(19) United States
(12) Patent Application Publication
(10) Pub. No.: US 2024/0346683 A1
(43) Pub. Date: Oct. 17, 2024

(54) OBJECT POSITION DETERMINATION METHOD IN THREE-DIMENSIONAL LOAD SPACE AND SERVER USING THE SAME

(71) Applicants: Hyundai Motor Company, Seoul (KR); Kia Corporation, Seoul (KR)

(72) Inventors: Sunjoo Moon, Suwon-si (KR); Wonseok Choi, Seongnam-si (KR); Hyejun Park, Seoul (KR)

(21) Appl. No.: 18/538,613

(22) Filed: Dec. 13, 2023

(30) Foreign Application Priority Data
Apr. 14, 2023 (KR) 10-2023-0049218
Jun. 23, 2023 (KR) 10-2023-0081457

(51) Int. Cl. G06T 7/70; G06T 7/13; G06T 19/20

(52) U.S. Cl. CPC G06T 7/70; G06T 7/13; G06T 19/20; G06T 2219/2004

(57) ABSTRACT

A method of determining a position corresponding to objects in a three-dimensional (3D) load space is provided. The method is performed by a processor and includes implementing a load space as the 3D load space, generating a first cube including a shape of a first object and a second cube including a shape of a second object to be loaded in the 3D load space, determining a first object position such that the first object is positioned closest to a reference point without deviating from an x-axis and a y-axis that meet at the reference point, wherein the reference point is one of a plurality of vertices of a lower face of the 3D load space, and determining a second object position such that the second object is positioned closest to the reference point without deviating from the x-axis and the y-axis and without overlapping the first object.

### CROSS-REFERENCE TO RELATED APPLICATIONS

This application claims the benefit of Korean Patent Application No. 10-2023-0049218, filed on Apr. 14, 2023, and Korean Patent Application No. 10-2023-0081457, filed on Jun. 23, 2023, which applications are hereby incorporated herein by reference.

### TECHNICAL FIELD

The present disclosure relates to an object position determination method in a three-dimensional (3D) load space and a server using the same.

### BACKGROUND

When objects are loaded in a specific space, because it is difficult to determine whether the objects to be loaded fit into the space before loading the objects to be loaded in the actual space, there may be cases in which a larger space than the space necessary for the objects to be loaded is used.

As such, using a larger space than the necessary space may result in waste of space or cost due to unnecessary use of a load space and may make efficient use of the load space difficult.

In addition, when a space determined to fit the space necessary for the objects to be loaded based on subjective determination is used without using a larger space than the necessary space, errors other than expected may occur during actual loading.

### SUMMARY

Embodiments of the present disclosure provide an object position determination method in a three-dimensional (3D) load space capable of loading objects in a load space in a virtual space and optimizing load positions and a server using the same.

A method of determining a position corresponding to each of a first object and a second object in a three-dimensional (3D) load space, performed by a processor, according to an embodiment of the disclosure includes implementing a load space as the 3D load space, generating a first cube including a shape of the first object and a second cube including a shape of the second object to be loaded in the 3D loading space, determining a first object position such that the first object is positioned closest to a reference point without deviating from an x-axis and a y-axis that meet at the reference point which is one of a plurality of vertices of a lower face of the 3D load space, and determining a second object position such that the second object is positioned closest to the reference point without deviating from the x-axis and the y-axis and without overlapping the first object.

The method may further include receiving a first input position of the first object and a second input position of the second object from a user terminal and determining a first adjustment position and a second adjustment position by adjusting a distance from each of the first input position and the second input position to the reference point, wherein the first input position and the second input position may be within the 3D load space.

The determining of the first adjustment position and the second adjustment position may include, at each of positions where the first object moves by a unit distance in an x-axis direction and in a y-axis direction from an n-th position where the first object moves n−1 times by the unit distance from the first input position, when a boundary of the first cube overlaps with a boundary of the 3D load space or a boundary of the second cube, determining that the first object is immovable, when the first object is immovable, determining the n-th position as the first adjustment position, and when the first object is movable from the n-th position by the unit distance in a first direction among the x-axis and the y-axis, determining a position at which the first object is moved by the unit distance in the first direction as an n+1-th position of the first object, wherein n is a natural number greater than or equal to 1.

When a time at which the first input position is received from the user terminal is before a time at which the second input position is received, the determining of the first adjustment position and the second adjustment position may further include determining the first adjustment position corresponding to the first object such that the first cube is positioned closest to the reference point without deviating from the x-axis and the y-axis, determining the second adjustment position corresponding to the second object such that the second cube is positioned closest to the reference point without deviating from the x-axis and the y-axis and without overlapping the first cube corresponding to the first adjustment position, and determining a first target position and a second target position respectively from the first adjustment position and the second adjustment position by adjusting positions such that the first object and the second object are positioned close to the reference point.

The determining of the first adjustment position and the second adjustment position may include, at each of positions where the first object moves by a unit distance in an x-axis direction and in a y-axis direction from an m-th position where the first object moves m−1 times by the unit distance from the first adjustment position, when a boundary of the first object overlaps with a boundary of the 3D load space or a boundary of the second object, determining that the first object is immovable, when the first object is immovable, determining the m-th position as the first target position, and when the first object is movable from the m-th position by the unit distance in a first direction among the x-axis and the y-axis, determining a position at which the first object is moved by the unit distance in the first direction as an m+1-th position of the first object, wherein m is a natural number greater than or equal to 1.

The method may further include determining a plurality of orders of an object of which a target position is to be determined among the first object and the second object and determining a first position corresponding to the first object and a second position corresponding to the second object according to each of the plurality of orders. The first position may be a position of the first object at which a boundary of the first object is to be positioned closest to the reference point without deviating from the x-axis and y-axis and without crossing a boundary of the second object, and the second position may be a position of the second object at which the boundary of the second object is to be positioned closest to the reference point without deviating from the x-axis and y-axis and without crossing the boundary of the first object.

The method may further include calculating a load rate corresponding to a target position of each of the first object and the second object determined according to each of the plurality of orders and determining the first position and the second position corresponding to orders of the lowest load rate among the plurality of orders respectively as the first target position and the second target position.

A server according to another embodiment of the disclosure includes a 3D load space implementation unit configured to implement a load space as a 3D load space, a virtual cube generation unit configured to generate a first cube including a shape of a first object and a second cube including a shape of a second object to be loaded in the 3D loading space, and a target position determination unit configured to determine a first object position such that the first object is positioned closest to a reference point without deviating from an x-axis and a y-axis that meet at the reference point which is one of a plurality of vertices of a lower face of the 3D load space and to determine a second position corresponding to the second object such that the second object is positioned closest to the reference point without deviating from the x-axis and the y-axis and without overlapping the first object.

The server may further include an adjustment position determination unit configured to, when receiving a first input position of the first object and a second input position of the second object from a user terminal, determine a first adjustment position and a second adjustment position by adjusting a distance from each of the first input position and the second input position to the reference point, and the first input position and the second input position may be within the 3D load space.

The adjustment position determination unit may determine that the first object is immovable when a boundary of the first cube overlaps with a boundary of the 3D load space or a boundary of the second cube, at each of positions where the first object moves by a unit distance in an x-axis direction and in a y-axis direction from an n-th position where the first object moves n−1 times by the unit distance from the first input position, when the first object is immovable, determine the n-th position as the first adjustment position, and when the first object is movable from the n-th position by the unit distance in a first direction among the x-axis and the y-axis, determine a position at which the first object is moved by the unit distance in the first direction as an n+1-th position of the first object, wherein n may be a natural number greater than or equal to 1.

When a time at which the first input position is received from the user terminal is before a time at which the second input position is received, the adjustment position determination unit may determine the first adjustment position corresponding to the first object such that the first cube is positioned closest to the reference point without deviating from the x-axis and the y-axis and determine the second adjustment position corresponding to the second object such that the second cube is positioned closest to the reference point without deviating from the x-axis and the y-axis and without overlapping the first cube corresponding to the first adjustment position.

The target position determination unit may determine the first target position and the second target position respectively from the first adjustment position and the second adjustment position by adjusting positions such that the first object and the second object are positioned close to the reference point.

The target position determination unit may determine that the first object is immovable when a boundary of the first object overlaps with a boundary of the 3D load space or a boundary of the second object, at each of positions where the first object moves by a unit distance in an x-axis direction and in a y-axis direction from an m-th position where the first object moves m−1 times by the unit distance from the first adjustment position, when the first object is immovable, determine the m-th position as the first target position, and when the first object is movable from the m-th position by the unit distance in a first direction among the x-axis and the y-axis, determine a position at which the first object is moved by the unit distance in the first direction as an m+1-th position of the first object, wherein m may be a natural number greater than or equal to 1.

The target position determination unit may determine a plurality of orders of an object of which a target position is to be determined among the first object and the second object and determine a first position corresponding to the first object and a second position corresponding to the second object according to each of the plurality of orders. The first position may be a position of the first object at which a boundary of the first object is to be positioned closest to the reference point without deviating from the x-axis and y-axis and without crossing a boundary of the second object, and the second position may be a position of the second object at which the boundary of the second object is to be positioned closest to the reference point without deviating from the x-axis and y-axis and without crossing the boundary of the first object.

The server may further include a load rate calculation unit configured to calculate a load rate corresponding to a target position of each of the first object and the second object determined according to each of the plurality of orders, and the target position determination unit may determine the first position and the second position corresponding to orders of the lowest load rate among the plurality of orders respectively as the first target position and the second target position.

According to embodiments of the present disclosure, by placing objects to be loaded in a load space in a virtual space, the optimal load space may be selected, and load positions in the corresponding space may be confirmed in advance.

According to embodiments of the present disclosure, it is possible to determine the load space without relying on subjective judgment, thereby reducing waste of space and cost due to unnecessary use of the load space and enabling efficient use of the load space.

Embodiments of the present disclosure may ensure optimal usability by confirming not only a load rate for load positions corresponding to the load order of objects arbitrarily determined by the user but also a load rate for the optimal load positions capable of efficiently utilizing the load space.

Embodiments of the present disclosure may be utilized to load objects in a container to simulate the optimal loading method and may be utilized to load moving packages to select a moving vehicle of the optimal size.

Embodiments of the present disclosure may be utilized in self-storage to enable easy access to the use of storage space by allowing a user to select a load space and directly put objects in the load space, and a use rate of self-storage may increase due to increased accessibility.

### BRIEF DESCRIPTION OF THE DRAWINGS

FIG. 1 is a block diagram schematically showing a load position determination system according to an embodiment.

FIG. 2 is a block diagram schematically showing a detailed configuration of a processor shown in FIG. 1.

FIG. 3 is a flowchart of an object position determination method in a three-dimensional (3D) load space according to an embodiment.

FIG. 4 is an exemplary diagram showing a load space according to an embodiment.

FIG. 5 is an exemplary diagram showing a cube including a shape of one object according to an embodiment.

FIG. 6 is an exemplary diagram of a user interface indicating a 3D load space and a cube according to an embodiment.

FIGS. 7 and 8 are exemplary diagrams for explaining input positions of two cubes corresponding to two objects according to an embodiment.

FIG. 9 is a detailed flowchart of step S400 shown in FIG. 3.

FIGS. 10A and 10B are plan views of a 3D load space and four objects for explaining a detailed order of FIG. 9.

FIG. 11 is an exemplary diagram for explaining an adjustment load rate according to an embodiment.

FIG. 12 is a detailed flowchart of step S700 shown in FIG. 3.

FIGS. 13A and 13B are plan views of a 3D load space and four objects for explaining a detailed order of FIG. 12.

FIG. 14 is an exemplary diagram for explaining a target load rate according to an embodiment.

FIGS. 15A and 15B are exemplary screen diagrams showing at least one object loaded in a 3D load space.

### DETAILED DESCRIPTION OF ILLUSTRATIVE EMBODIMENTS

Hereinafter, referring to the drawings, the embodiments disclosed in this specification will be described in detail, but the same or similar reference numerals are given to the same or similar constituent elements, and redundant descriptions thereof will be omitted. The suffixes “module” and/or “-portion” for the constituent element used in the following description are given or interchanged in consideration of only the ease of drafting the specification and do not have meanings or functions distinguished from each other by themselves. In addition, in describing the embodiments disclosed in this specification, when it is determined that a detailed description of a related known technology may obscure the gist of the exemplary embodiments disclosed in this specification, the detailed description thereof will be omitted. In addition, the attached drawings are only for easy understanding of the exemplary embodiments disclosed in this specification, the technical idea disclosed in this specification is not limited by the attached drawings, and it should be understood to include all modifications, equivalents, and substitutes included in the spirit and scope of the present disclosure.

The terms including ordinal numbers such as first, second, etc. may be used to describe various constituent elements, but the constituent elements are not limited by the terms. The terms are used only for the purpose of distinguishing one constituent element from another constituent element.

In the present application, terms such as “comprise” or “have” are intended to designate the presence of a feature, number, step, operation, constituent element, part, or combinations thereof described in the specification, and it should be understood that the terms do not preclude in advance the possibility of the presence or addition of one or more other features, numbers, steps, operations, constituent elements, parts, or combinations thereof.

Among configurations according to an embodiment, a program implemented as a set of instructions specifying a control algorithm necessary for controlling other configurations may be installed in a configuration controlling another configuration under specific control conditions. The control configuration may process input data and stored data to generate output data according to the installed program. The control configuration may include a non-volatile memory storing the program and a memory storing the data.

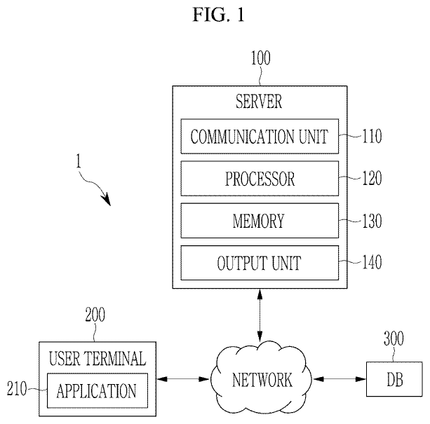

FIG. 1 is a block diagram schematically showing a load position determination system 1 according to an embodiment.

Referring to FIG. 1, the load position determination system 1 may include a server 100, a user terminal 200, and a database (DB) 300.

The server 100, the user terminal 200, and the DB 300 are connected to each other through a network.

The server 100 may include a communication unit 110, a processor 120, and an output unit 140. An application 210 may be installed on the user terminal 200. The DB 300 may include a load space, the shape of at least one object, etc. The DB 300 may be cloud storage or may be on-premises data storage.

The communication unit 110 may exchange signals, data, etc. through wired or wireless communication with the user terminal 200, the DB 300, etc.

The processor 120 may control operations of the communication unit 110, a memory 130, and the output unit 140. The processor 120 may implement a load space as a three-dimensional (3D) load space in a 3D virtual environment and generate at least one cube including the shape of at least one object in the 3D virtual environment.

Hereinafter, for convenience of explanation, it will be described that each of at least one cube including the shape of at least one object is a cube, but the disclosure is not limited thereto.

Hereinafter, it will be described that the number of at least one object is 2 or more, but this is for convenience of explanation and the disclosure is not limited thereto. In some embodiments, one cube including the shape of one object may be generated in the 3D virtual environment.

The processor 120 may generate a user interface indicating the 3D load space indicating the load space and a plurality of cubes corresponding to a plurality of objects and transmit the user interface to the user terminal 200 through the application 210.

The processor 120 refers to a configuration that processes calculation operations, logic operations, determination operations, etc. to provide a plurality of functions and may be implemented as hardware, software, or a combination of hardware and software. For example, the processor 120 may be implemented as software such as a task, class, subroutine, process, object, execution thread, or program performed in a predetermined area on the memory 130 or as hardware such as a field-programmable gate array (FPGA) or an application-specific integrated circuit (ASIC), and the processor 120 may also be implemented as a combination of the software and the hardware. The processor 120 may be included in a computer-readable storage medium or may be partially distributed in a plurality of computers.

The memory 130 may store a program for calculating a load rate in a 3D virtual environment (hereinafter referred to as a “load rate calculation program”) and a program for determining a position corresponding to each of a plurality of objects in the 3D load space (hereinafter referred to as a “load position determination program”). The processor 120 may execute the load rate calculation program and/or the load position determination program.

The user may input the position of each of the plurality of objects into the user terminal 200. The user terminal 200 may transmit the position of each of the plurality of objects input from the user to the server 100. The position of each of the plurality of objects may be disposed within the 3D load space indicating the load space.

The processor 120 may receive positions of the plurality of objects within the 3D load space (hereinafter, “input positions”) from the user terminal 200, determine an adjustment position moved from the input position of each of the plurality of objects so that the plurality of objects are arranged close to one reference point in the order in which the input positions are received, and determine a target position moved from the adjustment position of each of the plurality of objects so that the plurality of objects are arranged close to one reference point by combining the order in which the plurality of objects are arranged in various ways. The processor 120 may calculate a load rate (hereinafter, “adjustment load rate”) that appears when each of the plurality of objects is disposed at each corresponding adjustment position and a load rate (hereinafter, “target load rate”) that appears when each of the plurality of objects is disposed at each corresponding target position, and derive at least one arrangement order having a low target load rate from among arrangement orders corresponding to target positions.

The adjustment position and the target position may be determined by the processor 120 as the respective positions of the plurality of objects so as to be positioned closest to a reference point without deviating from the x-axis and y-axis that meet at the reference point which is one of a plurality of vertices of a lower face of the 3D load space.

Specifically, it is described assuming that the plurality of objects includes a first object and a second object. The processor 120 may determine a first position of the first object such that the first object is positioned closest to the reference point without deviating from the x-axis and y-axis that meet at the reference point. In addition, the processor 120 may determine a second position of the second object such that the second object is positioned closest to the reference point without deviating from the x-axis and y-axis that meet at the reference point and without overlapping the first object.

Here, the reference point may be a point having the largest coordinate value in an x-axis direction and a y-axis direction among four vertices of a lower face RTG1 of the 3D load space. For example, coordinates of a reference point P1 may be (0,0). Accordingly, the adjustment position and the target position that allow the plurality of objects to be positioned close to the reference point may be positions moved from the input position in the x-axis direction and/or y-axis direction which are directions toward the reference point P1.

The output unit 140 may transmit a screen displaying the 3D load space and a screen displaying the plurality of objects to the user terminal 200. Here, the screen displaying the plurality of objects may include one or more screens displaying the plurality of objects and/or a screen displaying a cube corresponding to each of the plurality of objects.

The output unit 140 may generate a screen displaying the calculated adjustment load rate, the target load rate, and at least one arrangement order having a low target load rate, and transmit the screen to the application 210. The application 210 may display the received screen through the user terminal 200.

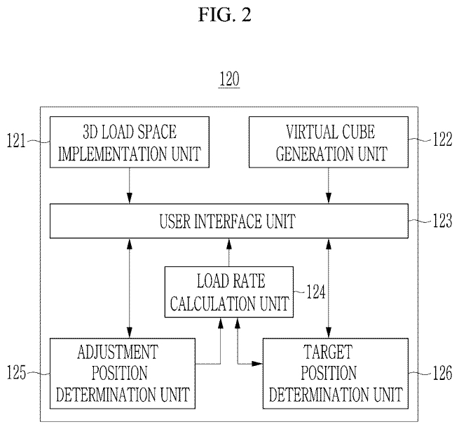

FIG. 2 is a block diagram schematically showing a detailed configuration of the processor 120 shown in FIG. 1.

Referring to FIG. 2, the processor 120 may include a 3D load space implementation unit 121, a virtual cube generation unit 122, a user interface unit 123, a load rate calculation unit 124, an adjustment position determination unit 125, and a target position determination unit 126.

The 3D load space implementation unit 121 may generate a 3D load space in which a load space is implemented in a 3D virtual environment. Here, the load space may be stored in the DB 300 or may be received from the user terminal 200.

The 3D virtual environment may be a virtual environment with respect to the x-axis, y-axis, and z-axis. The 3D load space may be implemented on the 3D virtual environment with respect to the x-axis, y-axis, and z-axis. The 3D load space may be expressed by using one grid as a unit. One grid may indicate a regular cube expressed as (x, y, z)=(1, 1, 1) in the 3D environment. 1, which indicates the size of a grid in each of the x-axis, y-axis, and z-axis, may correspond to, for example, 10 cm. Here, the size of the grid may be configured through a direct input of a user and may be determined in advance as initial information.

The virtual cube generation unit 122 may generate a plurality of cubes including shapes of a plurality of objects. Here, the plurality of objects may be stored in the DB 300 or may be received from the user terminal 200.

In some embodiments, a camera may be provided in the user terminal 200, and the user may photograph an area including a plurality of actual objects through the camera. The user terminal 200 may transmit image data photographed and generated through the camera to the server 100. The virtual cube generation unit 122 may detect the plurality of objects corresponding to the plurality of actual objects included in the image data based on the image data received from the user terminal 200. The virtual cube generation unit 122 may generate a virtual cube of the minimum size including the shape of each of the plurality of detected objects.

The virtual cube generation unit 122 may implement the shapes of the plurality of objects in the 3D virtual space and generate a cube including the shape of each of the plurality of objects to implement the cube in the 3D virtual space. Each of the plurality of objects may be loaded in the 3D load space.

Hereinafter, for convenience of explanation, each of the plurality of objects refers to an object implemented in the 3D virtual space.

The adjustment position determination unit 125 may determine an adjustment position of each of the plurality of objects in which an arrangement is adjusted so that the plurality of objects are positioned close to a reference point based on input positions received from the user terminal 200 and the order in which the input positions are received from the user terminal 200. The adjustment position may be a position where the cubes respectively corresponding to the plurality of objects do not overlap each other.

The target position determination unit 126 may determine a target position for each of the plurality of objects in which an arrangement is adjusted so that the plurality of objects are positioned close to the reference point based on the input position received from the user terminal 200 or the adjustment position according to each of a plurality of load object orders indicating all cases indicating the order in which the plurality of objects may be loaded. The target position may be a position where the plurality of objects do not overlap each other. Accordingly, a plurality of cubes corresponding to the plurality of objects at the target position may overlap each other.

The load rate calculation unit 124 may calculate an adjustment load rate corresponding to the adjustment position determined by the adjustment position determination unit 125 and calculate a target load rate corresponding to the target position determined by the target position determination unit 126. Here, the load rate is a value, obtained by subtracting the volume of an area overlapping with another cube among the plurality of cubes from the sum of volumes of the plurality of cubes corresponding to the plurality of objects, divided by the volume of the 3D load space.

The target position determination unit 126 may determine, as a final target position, a target position corresponding to at least one load object order having the lowest load rate among the plurality of load object orders of the plurality of objects. The target position determination unit 126 may generate a screen displaying the arrangement of the plurality of objects according to the final target position and the load object order corresponding to the final target position and provide the screen through the user interface unit 123.

Hereinafter, the load rate calculated by the load rate calculation unit 124 will be described as an adjustment load rate and a target load rate, but this is for convenience of explanation and the disclosure is not limited thereto. The load rate calculation unit 124 may calculate the load rate corresponding to the input position received from the user terminal 200.

The adjustment position is a position where the cubes respectively corresponding to the plurality of objects do not overlap each other, and the load rate is the sum of volumes of the plurality of cubes corresponding to the plurality of objects divided by the volume of the 3D load space, and thus, the adjustment load rate may be the same as a load rate corresponding to the input position received from the user terminal 200.

The user interface unit 123 may generate a user interface displaying the 3D load space and the plurality of generated cubes, a screen displaying the load rate, the adjustment load rate, and the target load rate corresponding to the input position calculated by the load rate calculation unit 124, and a screen displaying the adjustment position of each of the plurality of objects determined by the adjustment position determination unit 125 and the target position of each of the plurality of objects determined by the target position determination unit 126.

The user interface may express the size of the 3D load space and/or the plurality of objects (or cubes) in grid units and/or actual units (e.g., cm, etc.)

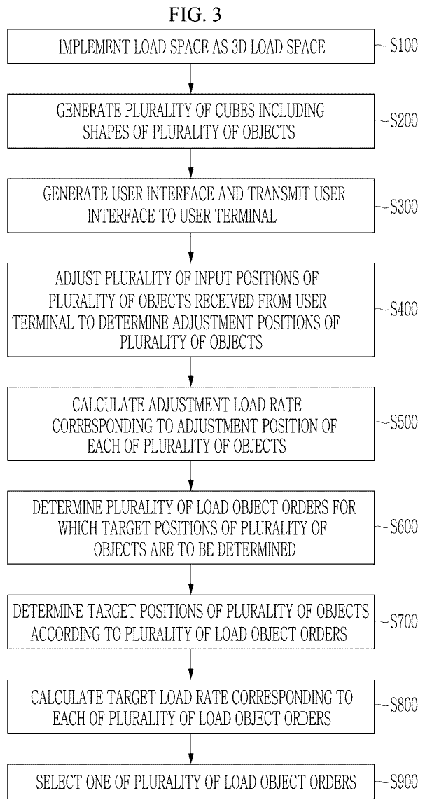

FIG. 3 is a flowchart of an object position determination method in a 3D load space according to an embodiment.

Hereinafter, descriptions of the 3D load space implementation unit 121, the virtual cube generation unit 122, the user interface unit 123, the load rate calculation unit 124, and the target position determination unit 126 which are redundant with the previous description may be omitted.

The processor 120 may execute a load rate calculation program and a load position determination program stored in a memory to perform the following operations.

Referring to FIG. 3, the 3D load space implementation unit 121 may implement a load space in a 3D environment (S100).

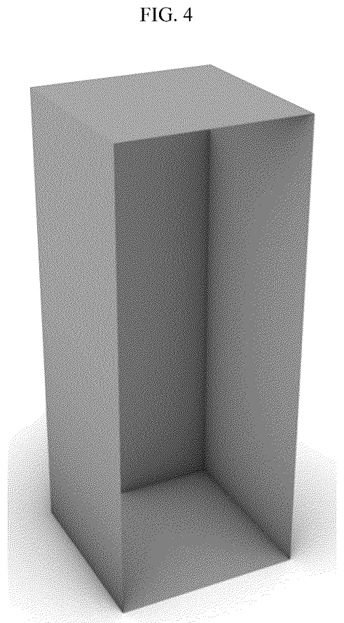

FIG. 4 is an exemplary diagram showing a load space according to an embodiment.

Referring to FIG. 4, the 3D load space implementation unit 121 may indicate a 3D load space indicating the load space as a cube in a virtual space.

Referring again to FIG. 3, the virtual cube generation unit 122 may implement shapes of a plurality of objects in the 3D virtual space and generate a plurality of cubes including the shapes of the plurality of objects (S200).

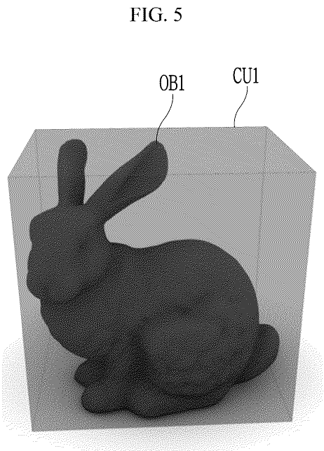

FIG. 5 is an exemplary diagram showing a cube including a shape of one object according to an embodiment.

Referring to FIG. 5, the virtual cube generation unit 122 may generate a cube CU1 including the shape of an object OB1. The cube CU1 may be a virtual cube of the minimum size including the shape of the object OB1.

Referring again to FIG. 3, the user interface unit 123 may generate a user interface indicating the plurality of objects generated in the 3D load space and the 3D virtual space and transmit the user interface to the user terminal 200 (S300).

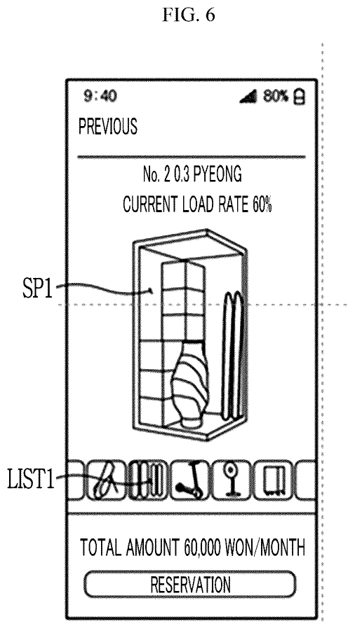

FIG. 6 is an exemplary diagram of a user interface showing a 3D load space SP1 and a cube according to an embodiment.

Referring to FIG. 6, the user interface unit 123 may generate the user interface showing the 3D load space SP1 and a list LIST1 indicating the plurality of objects (or cubes corresponding to the objects) on a screen and requesting positions of the plurality of objects. The output unit 140 may transmit the user interface generated by the user interface unit 123 to the application 210. The application 210 may display the screen displayed by the user interface through the user terminal 200.

The user may input positions of the objects into the user terminal 200 so that at least one of the list LIST1 indicating the plurality of objects is disposed within the 3D load space SP1. For example, the user may drag each of the plurality of objects indicated in the list LIST1 indicating the plurality of objects and drop the object to the position within the 3D load space SP1 through the user terminal 200.

Hereinafter, for convenience of explanation, it will be described that the user puts each of the plurality of objects within the 3D load space SP1, but the disclosure is not limited thereto. In some embodiments, the user may sequentially arrange the plurality of objects at random points in the 3D load space SP1 by drag and drop, and the server 100 may determine adjustment positions so that the plurality of objects are positioned close to a reference point according to the order in which the user arranges the plurality of objects regardless of points at which the user arranges the plurality of objects.

When the user inputs the positions of the plurality of objects through the user terminal 200, the application 210 may transmit the positions of the plurality of objects and the order in which the user arranges the plurality of objects in the 3D load space SP1 to the server 100 through the user terminal 200.

Hereinafter, input positions indicate the positions of the plurality of objects input by the user into the user terminal 200 and may be within a 3D load space in a 3D virtual environment.

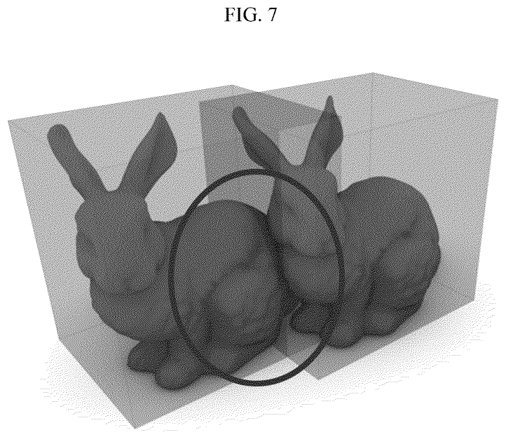

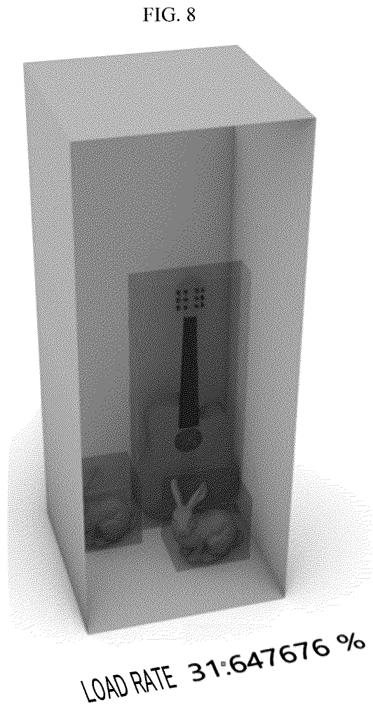

FIGS. 7 and 8 are exemplary diagrams for explaining input positions of two cubes corresponding to two objects according to an embodiment.

Referring to FIG. 7, within a 3D load space, a cube corresponding to each of a plurality of objects may overlap with a cube(s) corresponding to the remaining object(s) among the plurality of objects. However, even when one cube overlaps with another cube, the shape of an object indicated by one cube may not overlap with the shape of an object indicated by the other cube.

As shown in FIG. 7, input positions of the plurality of objects may be positions that the cube corresponding to each of the plurality of objects overlaps with the cube corresponding to the remaining object among the plurality of objects, and the shape of the object indicated by one cube does not overlap with the shape of the object indicated by the other cube.

Alternatively, the input positions of the plurality of objects may be positions that the cube corresponding to each of the plurality of objects does not overlap with the cube corresponding to the remaining object among the plurality of objects.

Hereinafter, for convenience of explanation, the input positions will be described assuming that the cube corresponding to each of the plurality of objects does not overlap with the cube corresponding to the remaining object among the plurality of objects.

Referring to FIG. 8, a position of each of the plurality of objects indicated by the input positions must be disposed inside the 3D load space, and even a part of each of the plurality of objects may not be positioned on a boundary or outside of the 3D load space. Therefore, the input position of each of the plurality of objects must not deviate from the x-axis and y-axis that meet at a reference point.

Referring to FIG. 8, the input positions of the plurality of objects may correspond to an arrangement such that a cube corresponding to each of the plurality of objects does not overlap with cubes corresponding to the remaining objects among the plurality of objects.

The load rate calculation unit 124 may calculate a load rate corresponding to the input position received from the user terminal 200, referring to FIG. 8, calculate the load rate corresponding to the input position received from the user terminal 200 as “31.647676%”, and transmit “31.647676%” to the user terminal 200.

A user interface of the user terminal 200 may display that the corresponding position may not be input when the shape of each of the plurality of objects overlaps with the shapes of the remaining objects or is not disposed inside the 3D load space. For example, when a first object overlaps with a second object, the user interface may display a mesh indicating the first object and the second object in red. In addition, the user interface may display the boundary of the 3D load space in green when the first object deviates from the boundary of the 3D load space.

Hereinafter, it will be described assuming that the input positions are input to allow the shape of each of the plurality of objects to overlap with the shapes of the remaining objects or not to be disposed inside the 3D load space.

Referring again to FIG. 3, the adjustment position determination unit 125 may adjust the plurality of input positions received from the user terminal 200 to determine the adjustment positions of the plurality of objects (S400).

The adjustment position determination unit 125 may adjusting a distance from each of the plurality of input positions to the reference point P1 to determine an adjustment position of each of the plurality of objects OB1_1 to OB1_4.

With respect to each object for which the user interface unit 123 receives an input position from the user terminal 200, the adjustment position determination unit 125 may determine a position, as an adjustment position of the corresponding object (e.g., OB1_1), such that a boundary of a cube (e.g., CUB1_1) corresponding to the corresponding object (e.g., OB1_1) does not collide with the boundary of the 3D load space and a plurality of cubes (e.g., CUB1_2 to CUB1_4) corresponding to the other objects (e.g., OB1_2 to OB1_4), and is positioned closest to the reference point P1.

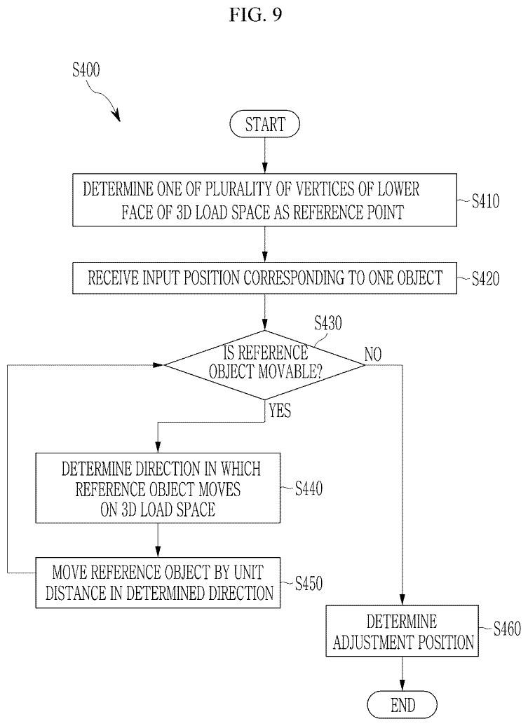

When a user sequentially inputs the positions of the plurality of objects into the user terminal 200, the adjustment position determination unit 125 may determine the adjustment position of each object according to the order in which the user arranges the plurality of objects. FIG. 9 is a detailed flowchart of step S400 shown in FIG. 3.

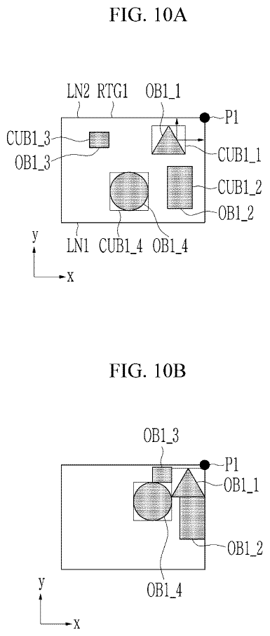

FIGS. 10A and 10B are plan views of a 3D load space and four objects for explaining a detailed order of FIG. 9.

Referring to FIG. 9, step S400 may include steps S410 to S460. Hereinafter, steps S410 to S460 will be described with reference to FIGS. 9, 10A, and 10B.

In FIGS. 10A and 10B, the cube CUB1_1 may indicate a lower face of a cube corresponding to the object OB1_1, the cube CUB1_2 may indicate a lower face of a cube corresponding to the object OB1_2, the cube CUB1_3 may indicate a lower face of a cube corresponding to the object OB1_3, and the cube CUB1_4 may indicate a lower face of a cube corresponding to the object OB1_4. Hereinafter, for convenience of explanation, the plurality of cubes CUB1_1 to CUB1_4 in FIGS. 10A and 10B will be described as respectively indicating the cubes corresponding to the plurality of objects OB1_1 to OB1_4.

Referring to FIG. 10B, the plurality of objects OB1_1 to OB1_4 may be arranged so that the cubes CUB1_1 to CUB1_4 respectively corresponding thereto do not overlap each other.

Hereinafter, for convenience of explanation, the order in which the adjustment position determination unit 125 receives positions of the plurality of objects OB1_1 to OB1_4 from the user terminal 200 is the object OB1_1, the object OB1_2, the object OB1_3, and the object OB1_4.

The adjustment position determination unit 125 may determine one vertex P1 of a plurality of vertices of a lower face of the 3D load space RTG1 as a reference point (S410).

In FIGS. 10A and 10B, the 3D load space RTG1 has four vertices, and the adjustment position determination unit 125 may determine one vertex P1 of the four vertices as the reference point. The reference point may have the largest coordinate value in the x-axis direction and y-axis direction among the four vertices of the lower face of the 3D load space RTG1. Hereinafter, coordinates of the reference point P1 will be described as (0,0).

When one side (e.g., a face with LN1 as a corner in FIG. 10A) of the 3D load space RTG1 is a space that may be opened and closed, the adjustment position determination unit 125 may determine one vertex P1 of vertices constituting the other side (e.g., a face with LN2 as a corner in FIG. 10A) facing one side that may be opened and closed and as the reference point.

In FIG. 9, the adjustment position determination unit 125 is shown to determine the reference point P1, but this is for an embodiment and the disclosure is not limited thereto. The reference point P1 may be previously determined as initial information.

The user interface unit 123 may receive an input position corresponding to one (e.g., OB1_1) of the plurality of objects OB1_1 to OB1_4 from the user terminal 200 (S420).

Hereinafter, it will be described assuming that the input position received by the user interface unit 123 in step S420 corresponds to the object OB1_1.

The adjustment position determination unit 125 may determine a reference object with respect to the object OB1_1 of which an input position has been received and may determine the adjustment position corresponding to the reference object OB1_1 such that a position of the reference object is positioned closest to the reference point P1 without deviating from the x-axis and y-axis that meet at the reference point P1.

Hereinafter, for convenience of explanation, the x-axis and y-axis that meet at the reference point P1 are assumed to be boundaries of the 3D load space RTG1.

The adjustment position determination unit 125 may determine whether the position of the reference object OB1_1 is movable by a unit distance so as to be positioned close to the reference point P1 on the 3D load space RTG1 (S430).

For example, the unit distance may be 1 grid unit.

Hereinafter, for convenience of explanation, when the adjustment position determination unit 125 moves a position of an object by the unit distance n−1 times (n is a natural number of 1 or more) in the x-axis direction or y-axis direction from an input position of the object, the position of the object is assumed to be an n-th position.

At both positions of the reference object OB1_1 moved by the unit distance in a first direction and in a second direction from a current position thereof, when a boundary of the cube CUB1_1 corresponding to the reference object OB1_1 overlaps with a boundary of the 3D load space RTG1 or boundaries of the plurality of cubes CUB1_2 to CUB1_4 corresponding to the other objects OB1_2 to OB1_4, the adjustment position determination unit 125 may determine the reference object OB1_1 to be immovable.

In determining whether the boundary of the cube CUB1_1 corresponding to the reference object OB1_1 overlaps with the boundaries of the plurality of cubes CUB1_2 to CUB1_4 corresponding to the other objects OB1_2 to OB1_4, the adjustment position determination unit 125 may determine a position of a cube (e.g., CUB1_2) corresponding to an object (e.g., OB1_2) of which an adjustment position is previously determined among the other objects OB1_2 to OB1_4 to be a position corresponding to the previously determined adjustment position. In addition, positions of cubes (e.g., CUB1_3 and CUB1_4) corresponding to objects (e.g., OB1_3 and OB1_4) of which adjustment positions have not been determined among the other objects OB1_2 to OB1_4 may correspond to input positions corresponding to the respective objects.

For example, when the adjustment position corresponding to the object OB1_2 is first determined and before the adjustment positions corresponding to the objects OB1_3 and OB1_4 are determined, in determining the adjustment position of the reference object OB1_1, the adjustment position determination unit 125 may determine whether the boundary of the cube CUB1_1 corresponding to the reference object OB1_1 overlaps with the boundary of the 3D load space RTG1, a boundary of the cube CUB1_2 corresponding to the previously determined adjustment position, or boundaries of the cubes CUB1_3 and CUB1_4 corresponding to the input position.

For example, at each of positions of the reference object OB1_1 moved by the unit distance in the x-axis direction and in the y-axis direction from the n-th position thereof, when the boundary of the cube CUB1_1 corresponding to the reference object OB1_1 overlaps with the boundary of the 3D load space RTG1 or the boundaries of the plurality of cubes CUB1_2 to CUB1_4 corresponding to the other objects OB1_2 to OB1_4, the adjustment position determination unit 125 may determine the reference object OB1_1 to be immovable.

In step S430, when the position of the reference object OB1_1 is movable by the unit distance so as to be positioned close to the reference point P1, the adjustment position determination unit 125 may determine a direction in which the reference object OB1_1 moves from the n-th position thereof on the 3D load space RTG1 (S440).

The direction in which the reference object OB1_1 moves from the n-th position thereof may be determined based on whether the boundary of the cube CUB1_1 corresponding to the reference object OB1_1 overlaps with the boundary of the 3D load space RTG1 or the boundaries of the plurality of cubes CUB1_2 to CUB1_4 corresponding to the other objects OB1_2 to OB1_4.

The direction in which the reference object OB1_1 moves from the n-th position thereof may be one of the x-axis direction and the y-axis direction. However, this is for convenience of explanation and the disclosure is not limited thereto.

At a position where the reference object OB1_1 is moved in the same direction as the first direction (e.g., the x-axis direction) moved from a previous position to the current position, when the boundary of the cube CUB1_1 corresponding to the reference object OB1_1 does not overlap with the boundary of the 3D load space RTG1 or the boundaries of the plurality of cubes CUB1_2 to CUB1_4 corresponding to the other objects OB1_2 to OB1_4, the adjustment position determination unit 125 may determine the same direction (e.g., the x-axis direction) as the first direction (e.g., the x-axis direction) to be a direction in which the reference object OB1_1 is to be moved.

In contrast, at the position where the reference object OB1_1 is moved in the first direction (e.g., the x-axis direction) from the previous position to the current position, when the boundary of the cube CUB1_1 corresponding to the reference object OB1_1 overlaps with the boundary of the 3D load space RTG1 or the boundaries of the plurality of cubes CUB1_2 to CUB1_4 corresponding to the other objects OB1_2 to OB1_4, the adjustment position determination unit 125 may determine a direction (e.g., the y-axis direction) different from the first direction (e.g., the x-axis direction) in which the reference object OB1_1 is moved from the previous position to the current position to be a direction in which the reference object OB1_1 is to be moved.

For example, at a position where the adjustment position determination unit 125 moves the reference object OB1_1 from an n−1-th position thereof to the n-th position thereof in the x-axis direction, and moves the reference object OB1_1 from the n-th position thereof in the x-axis direction, when the boundary of the cube CUB1_1 corresponding to the reference object OB1_1 overlaps with the boundary of the 3D load space RTG1 or the boundaries of the plurality of cubes CUB1_2 to CUB1_4 corresponding to the other objects OB1_2 to OB1_4, the adjustment position determination unit 125 may determine the position where the reference object OB1_1 is moved in the y-axis direction from the n-th position to be an n+1-th position of the reference object OB1_1.

The adjustment position determination unit 125 may move the position of the reference object OB1_1 by the unit distance in a direction determined among the x-axis direction and the y-axis direction on the 3D load space RTG1 (S450).

The n+1-th position where the adjustment position determination unit 125 moves the reference object OB1_1 n times may be closer to the reference point P1 than the n-th position where the adjustment position determination unit 125 moves the reference object OB1_1 n−1 times.

For example, the adjustment position determination unit 125 may calculate a first distance from the n-th position of the reference object OB1_1 to the reference point P1 and calculate a second distance from the n+1-th position of the reference object OB1_1 to the reference point P1. Here, the second distance may be less than or equal to the first distance.

Following step S450, step S430 may be performed.

When the position of the reference object OB1_1 is immovable by the unit distance so as to be positioned close to the reference point P1 in step S430, the adjustment position determination unit 125 may determine the current position of the reference object OB1_1 to be the adjustment position of the reference object OB1_1 (S460).

For example, in both cases where the adjustment position determination unit 125 moves the reference object OB1_1 from the n−1-th position thereof to the n-th position thereof in the x-axis direction and moves the reference object OB1_1 from the n-th position thereof in the x-axis direction and in the y-axis direction, when the boundary of the cube CUB1_1 corresponding to the reference object OB1_1 overlaps with the boundary of the 3D load space RTG1 or the boundaries of the plurality of cubes CUB1_2 to CUB1_4 corresponding to the other objects OB1_2 to OB1_4, the adjustment position determination unit 125 may determine the n-th position of the reference object OB1_1 to be the adjustment position of the reference object OB1_1.

In FIG. 9, steps S430 to S450 are shown as being performed sequentially, but the disclosure is not limited to this order. In some embodiments, the adjustment position determination unit 125 may determine a position where each object moves from the n−1-th position in the first direction among the x-axis direction and y-axis direction to be the n-th position, and, when it is possible to move each object by the unit distance in the first direction from the n-th position, may determine the position in which each object is moved by the unit distance in the first direction to be the n+1-th position. When movement in the first direction is impossible but movement is possible in the second direction among the x-axis direction and y-axis direction, the adjustment position determination unit 125 may determine the position in which each object is moved by the unit distance in the second direction to be the n+1-th position. In addition, when movement in the first direction is impossible and movement in the second direction is impossible, the adjustment position determination unit 125 may determine the n-th position of the object to be the adjustment position.

In step S420, the input position of each of the plurality of objects OB1_1 to OB1_4 may be received, and therefore, steps S420 to S460 may be repeated until the adjustment position of each of the plurality of objects OB1_1 to OB1_4 is determined.

When the user arranges the object OB1_1, the object OB1_2, the object OB1_3, and the object OB1_4 on the 3D load space RTG1 in this order, the plurality of objects OB1_1 to OB1_4 arranged as illustrated in FIG. 10A may move so as to be closer to the reference point P1 in the order of the object OB1_1, the object OB1_2, the object OB1_3, and the object OB1_4 through steps S410 to S460, and may be arranged as illustrated in FIG. 10B.

Referring again to FIG. 3, the load rate calculation unit 124 may calculate an adjustment load rate in correspondence to the adjustment position of each of the plurality of objects OB1_1 to OB1_4 (S500).

Hereinafter, the adjustment load rate may be the load rate of each of the plurality of objects OB1_1 to OB1_4 in the 3D load space RTG1 when the plurality of objects OB1_1 to OB1_4 are disposed at the respective corresponding adjustment positions.

The user interface unit 123 may generate a screen displaying the calculated adjustment load rate. The screen displaying the adjustment load rate may be expressed as a percentage in units of % or may be displayed as a bar graph, etc.

The user interface unit 123 may transmit the generated screen to the application 210, and the application 210 may display the screen through the user terminal 200.

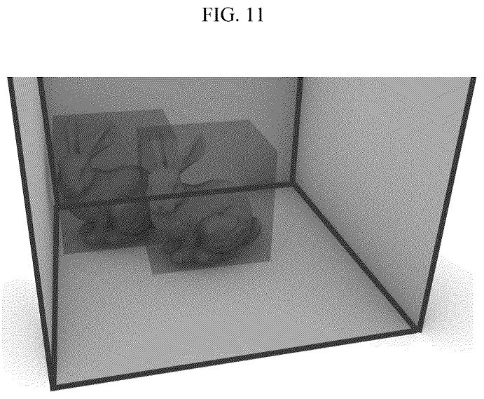

FIG. 11 is an exemplary diagram for explaining an adjustment load rate according to an embodiment.

Referring to FIG. 11, the load rate calculation unit 124 may calculate the adjustment load rate by dividing the volume of each of a plurality of cubes corresponding to a plurality of objects disposed at the respective adjustment positions by the volume of a 3D load space.

$$C = adjustment load rate ( \% ) = B / A * 100.$$

With reference to the examples of FIGS. 10A and 10B, here, A may denote the volume of the 3D load space corresponding to the lower face RTG1, and B may denote the sum of the volume of each of the plurality of cubes CUB1_1 to CUB1_4.

Referring again to FIG. 3, the target position determination unit 126 may adjust the adjustment position of each of the plurality of objects OB1_1 to OB1_4 to determine a plurality of load object orders for which target positions are to be determined (S600).

Hereinafter, the target position refers to a position determined by the target position determination unit 126 as the optimal position for each of the plurality of objects and may be a position in a 3D virtual environment.

The load object order may be the order in which the target positions of the plurality of objects are to be determined. The target position determination unit 126 may derive all combinations indicating the load object orders of the plurality of objects. When the number of the plurality of objects is X, the number of the plurality of load object orders may be X factorial.

For example, when the number of the plurality of objects is 4, the plurality of load object orders may be a total number of 24 including an object order of 1, 2, 3, and 4, an object order of 1, 2, 4, and 3, an object order of 1, 3, 2, and 4, an object order of 1, 3, 4, and 2, an object order of 1, 4, 2, and 3, an object order of 1, 4, 3, and 2, an object order of 2, 1, 3, and 4, an object order of 2, 1, 4, and 3, an object order of 2, 3, 1, and 4, an object order of 2, 3, 4, and 1, an object order of 2, 4, 1, and 3, an object order of 2, 4, 3, and 1, an object order of 3, 1, 2, and 4, an object order of 3, 1, 4, and 2, an object order of 3, 2, 1, and 4, an object order of 3, 2, 4, and 1, an object order of 3, 4, 1, and 2, an object order of 3, 4, 2, and 1, an object order of 4, 1, 2, and 3, an object order of 4, 1, 3, and 2, an object order of 4, 2, 1, and 3, an object order of 4, 2, 3, and 1, an object order of 4, 3, 1, and 2, and an object order of 4, 3, 2, and 1.

The target position determination unit 126 may respectively determine the target positions of the plurality of objects according to the plurality of load object orders with respect to the plurality of load object orders (S700).

The target position determination unit 126 may adjust a distance from each of a plurality of adjustment positions to the reference point P1 to determine the target position of each of the plurality of objects OB2_1 to OB2_4.

With respect to the adjustment position of each of the plurality of objects determined by the adjustment position determination unit 125, the target position determination unit 126 may determine a position at which a boundary of each object (e.g., OB1_1) is closest to the reference point P1 without crossing a boundary of the 3D load space and other objects (e.g., OB1_2 to OB1_4) according to the load object orders to a target position of the corresponding object (e.g., OB1_1).

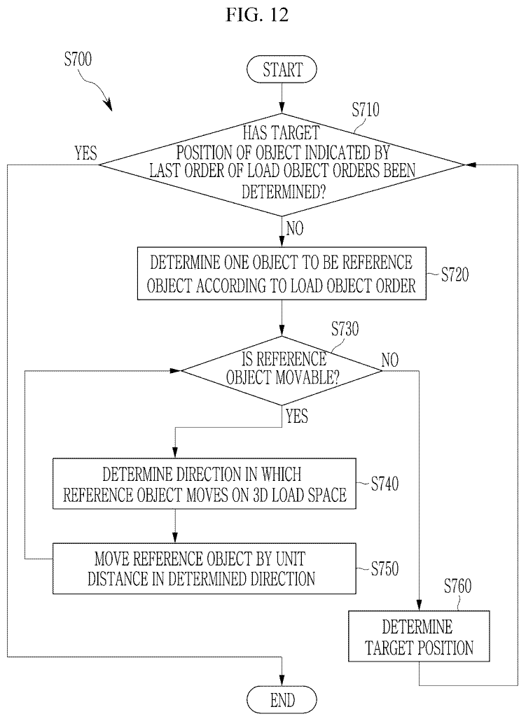

FIG. 12 is a detailed flowchart of step S700 shown in FIG. 3.

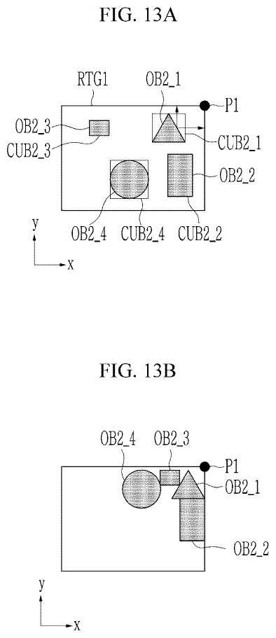

FIGS. 13A and 13B are plan views of a 3D load space and four objects for explaining a detailed order of FIG. 12.

Referring to FIG. 12, step S700 may include steps S710 to S760.

Hereinafter, steps S710 to S760 will be described with reference to FIGS. 12, 13A, and 13B.

Referring to FIG. 13B, a plurality of objects OB2_1 to OB2_4 may be arranged so as not to overlap each other from respective positions in FIG. 13A.

In FIGS. 13A and 13B, the cube CUB2_1 may indicate a lower face of a cube corresponding to the object OB2_1, the cube CUB2_2 may indicate a lower face of a cube corresponding to the object OB2_2, the cube CUB2_3 may indicate a lower face of a cube corresponding to the object OB2_3, and the cube CUB2_4 may indicate a lower face of a cube corresponding to the object OB2_4.

Hereinafter, for convenience of explanation, the plurality of cubes CUB2_1 to CUB2_4 in FIGS. 13A and 13B will be described as respectively indicating the cubes corresponding to the plurality of objects OB2_1 to OB2_4.

Referring to FIGS. 10A, 10B, 13A, and 13B, each position arranged in FIG. 13B is compared to each position arranged in FIG. 10B, and each of the cubes CUB2_1-CUB2_4 may overlap each other. This is because, in FIG. 13B, the boundaries are arranged so as not to overlap based on the plurality of items (OB2_1-OB2_4) rather than each hexahedron (CUB2_1-CUB2_4).

A load object order corresponding to an arrangement in FIG. 13B may be the order of the object OB2_1, the object OB2_2, the object OB2_3, and the object OB2_4.

Hereinafter, the plurality of objects OB2_1 to OB2_4 are shown and described in FIGS. 13A and 13B in order to distinguish the adjustment positions of the plurality of objects OB1_1 to OB1_4 in FIGS. 10A and 10B from the target positions of the plurality of objects OB2_1 to OB2_4 in FIGS. 13A and 13B.

When a target position of an object indicated by a last order of the load object orders has not been determined (No in S710), the target position determination unit 126 may determine one object to be a reference object according to one load object order (S720).

The target position determination unit 126 may determine whether a position of the reference object OB2_1 is movable by a unit distance so as to be positioned close to the reference point on the 3D load space (S730).

Hereinafter, it will be described assuming that the reference object is the object OB2_1.

Hereinafter, for convenience of explanation, when the target position determination unit 126 moves a position of an object in the x-axis direction or y-axis direction by a unit distance m−1 times (m is a natural number of 1 or more) from an adjustment position (or input position) of the object, the position of the object is assumed to be an m-th position.

At both positions of the reference object OB2_1 moved by the unit distance in a first direction and in a second direction from a current position thereof, when a boundary of the reference object OB2_1 overlaps with a boundary of the 3D load space or boundaries of the other objects OB2_2 to OB2_4, the target position determination unit 126 may determine the reference object OB2_1 to be immovable.

In determining whether the boundary of the reference object OB2_1 overlaps with the boundaries of the other objects OB2_2 to OB2_4, the target position determination unit 126 may determine a position of an object (e.g., OB2_2) of which a target position is previously determined among the other objects OB2_2 to OB2_4 to be the previously determined target position. In addition, positions of objects (e.g., OB2_3 and OB2_4) of which target positions have not been determined among the other objects OB2_2 to OB2_4 may be adjustment positions or input positions corresponding to the respective objects.

For example, when the target position corresponding to the object OB2_2 is first determined and before the target positions corresponding to the objects OB2_3 and OB2_4 are determined, in determining the target position of the reference object OB2_1, the target position determination unit 126 may determine whether the boundary of the reference object OB2_1 overlaps with the boundary of the 3D load space, the boundary of the object OB2_2 at the previously determined target position, or the boundaries of the objects OB2_3 and OB2_4 at the corresponding adjustment positions.

When determining a target position of an object, the target position determination unit 126 allows a boundary of the object itself not to overlap with a boundary of another object or the boundary of the 3D load space. This is different in that when the adjustment position determination unit 125 determines an adjustment position of an object, a boundary of a cube including the object does not overlap with a boundary of a cube of another object or the boundary of the 3D load space.

For example, at both positions of the reference object OB2_1 moved by the unit distance in the x-axis direction and in the y-axis direction from the m-th position thereof, when the boundary of the reference object OB2_1 overlaps with the boundary of the 3D load space or the boundaries of the other objects OB2_2 to OB2_4, the target position determination unit 126 may determine the reference object OB2_1 to be immovable.

In step S730, when the position of the reference object OB2_1 is movable by the unit distance so as to be positioned close to the reference point, the target position determination unit 126 may determine a direction in which the reference object OB2_1 moves from the m-th position thereof by the unit distance on the 3D load space (S740).

The direction in which the reference object OB2_1 moves from the m-th position thereof may be determined based on whether the boundary of the reference object OB2_1 overlaps with the boundary of the 3D load space or the boundaries of the other objects OB2_2 to OB2_4.

The direction in which the reference object OB2_1 moves from the m-th position thereof may be one of the x-axis direction and the y-axis direction. However, this is for convenience of explanation, and the disclosure is not limited thereto.

At a position where the reference object OB2_1 is moved in the same direction as the first direction (e.g., the x-axis direction) from a previous position to a current position, when the boundary of the reference object OB2_1 does not overlap with the boundary of the 3D load space or the boundaries of the other objects OB2_2 to OB2_4, the target position determination unit 126 may determine the same direction (e.g., the x-axis direction) as the first direction (e.g., the x-axis direction) to be a direction in which the reference object OB2_1 is to be moved.

In contrast, at the position where the reference object OB2_1 is moved in the same direction as the first direction (e.g., the x-axis direction) from the previous position to the current position, when the boundary of the reference object OB2_1 overlaps with the boundary of the 3D load space or the boundaries of the other objects OB2_2 to OB2_4, the target position determination unit 126 may determine a direction (e.g., the y-axis direction) different from the first direction (e.g., the x-axis direction) in which the reference object OB2_1 is moved to be a direction in which the reference object OB2_1 is to be moved.

For example, at a position where the target position determination unit 126 moves the reference object OB2_1 from an m−1-th position thereof to the m-th position thereof in the x-axis direction and moves the reference object OB2_1 from the m-th position thereof in the x-axis direction, when the boundary of the reference object OB2_1 overlaps with the boundary of the 3D load space or the boundaries of the other objects OB1_2 to OB1_4, the target position determination unit 126 may determine the position where the reference object OB2_1 is moved in the y-axis direction from the m-th position to be an m+1-th position of the reference object OB2_1.

The target position determination unit 126 may move the position of the reference object OB2_1 by the unit distance in a direction determined among the x-axis direction and the y-axis direction on the 3D load space (S750).

The m+1-th position where the target position determination unit 126 moves the reference object OB2_1 m times may be closer to the reference point P1 than the m-th position where the target position determination unit 126 moves the reference object OB2_1 m−1 times.

For example, the target position determination unit 126 may calculate a first distance from the m-th position of the reference object OB2_1 to the reference point P1 and calculate a second distance from the m+1-th position of the reference object OB2_1 to the reference point P1. Here, the second distance may be less than or equal to the first distance.

Following step S750, step S730 may be performed.

When the position of the reference object OB2_1 is immovable by the unit distance so as to be positioned close to the reference point P1 in step S730, the target position determination unit 126 may determine the current position of the reference object OB2_1 to be the target position of the reference object OB2_1 (S760).

For example, in both cases where the target position determination unit 126 moves the reference object OB2_1 from the m−1-th position thereof to the m-th position thereof in the x-axis direction and moves the reference object OB2_1 from the m-th position thereof in the x-axis direction and in the y-axis direction, when the reference object OB2_1 overlaps with the boundary of the 3D load space or the boundaries of the other objects OB2_2 to OB2_4, the target position determination unit 126 may determine the m-th position of the reference object OB2_1 to be the target position of the reference object OB2_1.

In FIG. 12, steps S730 to S750 are shown as being performed sequentially, but the disclosure is not limited to this order. In some embodiments, the target position determination unit 126 may determine a position where each object moves from the m−1-th position in the first direction among the x-axis direction and y-axis direction to be the m-th position, and, when it is possible to move each object by the unit distance in the first direction from the m-th position, may determine the position in which each object is moved by the unit distance in the first direction to be the m+1-th position. When movement in the first direction is impossible but movement is possible in the second direction among the x-axis direction and y-axis direction, the target position determination unit 126 may determine the position in which each object is moved by the unit distance in the second direction to be the m+1-th position. In addition, when movement in the first direction is impossible and movement in the second direction is impossible, the target position determination unit 126 may determine the m-th position of the object to be the target position.

When the target position of the object indicated by the last order of the load object orders has been determined (Yes in S710), the target position determination unit 126 may end step S700.

Therefore, steps S710 to S760 are performed with respect to each of the plurality of load object orders, and the target position determination unit 126 may repeat steps S720 to S750 until the target positions of all of the plurality of objects are determined in order, in correspondence to each of the plurality of load object orders.

For example, when one load object order among the plurality of load object orders is 1, 2, 3, and 4, the target position determination unit 126 may determine object 1 as a reference object (S720), determine a target position of the object 1 (S760), determine object 2 as the reference object (S720), determine a target position of the object 2 (S760), determine object 3 as the reference object (S720), determine a target position of the object 3 (S760), determine object 4 as the reference object (S720), and determine a target position of the object 4 (S760).

In addition, when the target position of the object 4 which is the last order is determined (S760), the target position determination unit 126 may repeat steps S720 to S750 until target positions of all of the plurality of objects are determined with respect to a load object order different from an order in which target positions have been already determined among the plurality of load object orders.

The plurality of objects OB2_1 to OB2_4 arranged as illustrated in FIG. 13A may move so as to be closer to the reference point P1 in the order of the object OB2_1, the object OB2_2, the object OB2_3, and the object OB2_4 through step S700, and may be arranged as illustrated in FIG. 13B.

In FIG. 4, it is shown that the adjustment position determination unit 125 adjusts a plurality of input positions of a plurality of objects received from a user terminal to determine adjustment positions of the plurality of objects (S400), and the target position determination unit 126 determines target positions of the plurality of objects based on the adjustment positions of the plurality of objects (S700), but the embodiment is not limited thereto.

In some embodiments, the target position determination unit 126 may adjust the plurality of input positions of the plurality of objects received from the user terminal to determine the target positions of the plurality of objects (S700).

Referring back to FIG. 3, the load rate calculating unit 124 may calculate a target load rate corresponding to each of the plurality of load object orders (S800).

Hereinafter, the target load rate may be a load rate occupied by the volume of the plurality of objects on the 3D load space when each of the plurality of objects is disposed at the corresponding target position.

The load rate calculation unit 124 may calculate the target load rate by dividing the volume of each of a plurality of cubes indicated by the target position of each of the plurality of objects by the volume of the 3D load space. When each of the plurality of cubes indicated by the target position overlaps with the remaining cube(s) among the plurality of cubes, the load rate calculation unit 124 may calculate the target load rate by dividing the volume of the 3D load space, excluding the overlapping volume from the sum of the volume of each of the plurality of cubes.

$$F = target load rate ( \% ) = E / D * 100.$$

With reference to the examples of FIGS. 13A and 13B, here, D denotes the volume of the 3D load space corresponding to the lower face RTG1, and E may denote a value obtained by excluding the volume of overlapping areas among the plurality of cubes from the sum of the volume of each of the plurality of cubes corresponding to the plurality of objects OB2_1 to OB2_4.

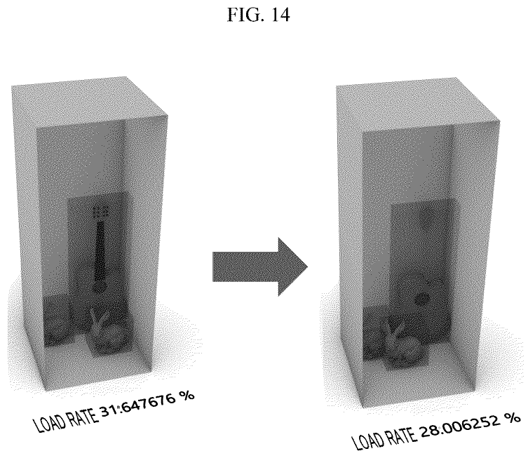

FIG. 14 is an exemplary diagram for explaining a target load rate according to an embodiment.

Referring to FIG. 14, the target load rate may be a value less than or equal to an input load rate calculated in step S500.

For example, the load rate corresponding to an input position received from the user terminal 200 or the adjustment load rate calculated in step S500 may be 31.647676%, and the target load rate calculated in step S800 may be 28.006252%.

The target position determination unit 126 may select at least one load object order in the order of the lowest load rate among a plurality of loaded objects based on the target load rate corresponding to each of a plurality of load object orders (S900).

The target position determination unit 126 may determine a target position of each of the plurality of objects according to the at least one load object order as a final target position.

The user interface unit 123 may generate a screen displaying the target load rate corresponding to the final target position. The screen displaying the target load rate corresponding to the final target position may be expressed as a percentage in units of % or may be displayed as a bar graph, etc.

The user interface unit 123 may transmit the generated screen to the application 210, and the application 210 may display the screen through the user terminal 200.

The user interface unit 123 may generate a screen displaying the plurality of objects loaded in a 3D load space to be positioned at the final target position and transmit the screen to the application 210. The user interface unit 123 may display on the screen the load object order to be loaded to the final target position.

The application 210 may display the screen through the user terminal 200.

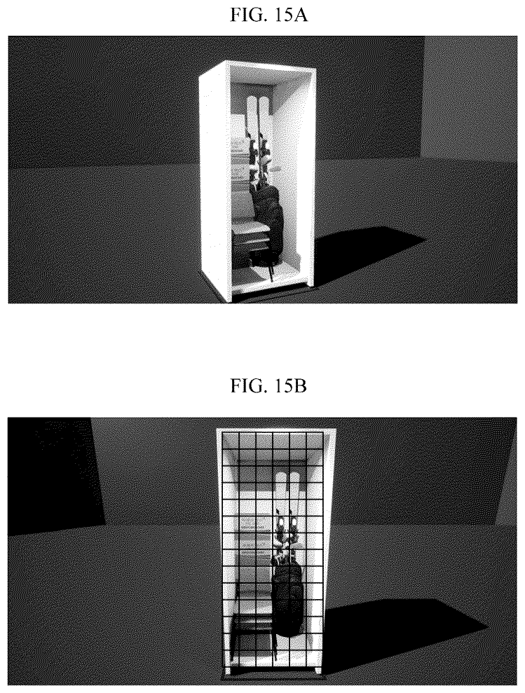

FIGS. 15A and 15B are exemplary screen diagrams showing a plurality of objects loaded in a 3D load space.

Referring to FIG. 15A, a screen displayed on the user terminal 200 may display the plurality of objects loaded in the 3D load space in a 3D environment.

Referring to FIG. 15B, the 3D load space and the plurality of objects may be displayed in grid units on the screen displayed on the user terminal 200.

Although the embodiments of the present disclosure have been described in detail above, the scope of the present disclosure is not limited thereto, and various modifications and improvements made by those skilled in the art in the field to which the present disclosure pertains are also within the scope of the present disclosure.

The following reference identifiers may be used in connection with the drawings to describe various features of embodiments of the present disclosure.
1: load position determination system
100: server
110: communication unit
120: processor
121: 3D load space implementation unit
122: virtual cube generation unit
123: user interface unit
124: load rate calculation unit
125: adjustment position determination unit
126: target position determination unit
130: memory
140: output unit
200: user terminal
210: application
300: database

What is claimed is:

1. A method of determining a position corresponding to each of a first object and a second object in a three-dimensional (3D) load space, the method being performed by a processor, and the method comprising:
implementing a load space as the 3D load space;
generating a first cube including a shape of the first object and a second cube including a shape of the second object to be loaded in the 3D load space;
determining a first object position such that the first object is positioned closest to a reference point without deviating from an x-axis and a y-axis that meet at the reference point, wherein the reference point is one of a plurality of vertices of a lower face of the 3D load space; and
determining a second object position such that the second object is positioned closest to the reference point without deviating from the x-axis and the y-axis and without overlapping the first object.

2. The method of claim 1, further comprising:
receiving a first input position of the first object and a second input position of the second object from a user terminal, wherein the first input position and the second input position are within the 3D load space; and
determining a first adjustment position and a second adjustment position by adjusting a distance from each of the first input position and the second input position to the reference point.

3. The method of claim 2, wherein determining the first adjustment position and the second adjustment position comprises:
determining whether the first object is movable;
determining that the first object is not movable in a case in which a boundary of the first cube overlaps with a boundary of the 3D load space or a boundary of the second cube after the first object is moved by a unit distance in an x-axis direction and in a y-axis direction from an n-th position where the first object moves n−1 times by the unit distance from the first input position, wherein n is a natural number greater than or equal to 1;
in response to a determination that the first object is not movable, determining the n-th position as the first adjustment position; and
in response to a determination that the first object is movable from the n-th position by the unit distance in a first direction among the x-axis direction and the y-axis direction, determining a position at which the first object is moved by the unit distance in the first direction as an n+1-th position of the first object.

4. The method of claim 2, wherein, in a case in which a time at which the first input position is received from the user terminal is before a time at which the second input position is received, determining the first adjustment position and the second adjustment position further comprises:
determining the first adjustment position corresponding to the first object such that the first cube is positioned closest to the reference point without deviating from the x-axis and the y-axis;
determining the second adjustment position corresponding to the second object such that the second cube is positioned closest to the reference point without deviating from the x-axis and the y-axis and without overlapping the first cube corresponding to the first adjustment position; and
determining a first target position and a second target position respectively from the first adjustment position and the second adjustment position by adjusting positions such that the first object and the second object are positioned closer to the reference point.

5. The method of claim 4, wherein determining the first adjustment position and the second adjustment position comprises:
determining whether the first object is movable;
determining that the first object is not movable in a case in which a boundary of the first object overlaps with a boundary of the 3D load space or a boundary of the second object after the first object is moved by a unit distance in an x-axis direction and in a y-axis direction from an m-th position where the first object moves m−1 times by the unit distance from the first adjustment position, wherein m is a natural number greater than or equal to 1;
in response to a determination that the first object is not movable, determining the m-th position as the first target position; and
in response to a determination that the first object is movable from the m-th position by the unit distance in a first direction among the x-axis direction and the y-axis direction, determining a position at which the first object is moved by the unit distance in the first direction as an m+1-th position of the first object.

6. The method of claim 4, further comprising:
determining a plurality of orders of an object of which a target position is to be determined among the first object and the second object; and
determining a first position corresponding to the first object and a second position corresponding to the second object according to each of the plurality of orders.

7. The method of claim 6, wherein:
the first position is a position of the first object at which a boundary of the first object is to be positioned closest to the reference point without deviating from the x-axis and the y-axis and without crossing a boundary of the second object; and
the second position is a position of the second object at which the boundary of the second object is to be positioned closest to the reference point without deviating from the x-axis and the y-axis and without crossing the boundary of the first object.

8. The method of claim 7, further comprising:
calculating a load rate corresponding to the target position of each of the first object and the second object determined according to each of the plurality of orders; and
determining the first position and the second position corresponding to orders of a lowest load rate among the plurality of orders respectively as the first target position and the second target position.

9. A server comprising:
one or more processors; and
a storage device storing a program to be executed by the one or more processors, the program including instructions for:
implementing a load space as a 3D load space;
generating a first cube including a shape of a first object and a second cube including a shape of a second object to be loaded in the 3D loading space;
determining a first object position such that the first object is positioned closest to a reference point without deviating from an x-axis and a y-axis that meet at the reference point, wherein the reference point is one of a plurality of vertices of a lower face of the 3D load space; and
determining a second object position corresponding to the second object such that the second object is positioned closest to the reference point without deviating from the x-axis and the y-axis and without overlapping the first object.

10. The server of claim 9, wherein the program further includes instructions for determining a first adjustment position and a second adjustment position by adjusting a distance from each of a first input position of the first object and a second input position of the second object to the reference point, wherein the first input position and the second input position are inputs to a user terminal and may be within the 3D load space.

11. The server of claim 10, wherein the program further includes instructions for:
determining whether the first object is movable;
determining that the first object is not movable in a case in which a boundary of the first cube overlaps with a boundary of the 3D load space or a boundary of the second cube after the first object is moved by a unit distance in an x-axis direction and in a y-axis direction from an n-th position where the first object moves n−1 times by the unit distance from the first input position, wherein n is a natural number greater than or equal to 1;
in response to a determination that the first object is not movable, determining the n-th position as the first adjustment position; and
in response to a determination that the first object is movable from the n-th position by the unit distance in a first direction among the x-axis direction and the y-axis direction, determining a position at which the first object is moved by the unit distance in the first direction as an n+1-th position of the first object.

12. The server of claim 10, wherein, in a case in which a time at which the first input position is received from the user terminal is before a time at which the second input position is received, the program further includes instructions for:
determining the first adjustment position corresponding to the first object such that the first cube is positioned closest to the reference point without deviating from the x-axis and the y-axis; and
determining the second adjustment position corresponding to the second object such that the second cube is positioned closest to the reference point without deviating from the x-axis and the y-axis and without overlapping the first cube corresponding to the first adjustment position.

13. The server of claim 12, wherein the program further includes instructions for determining a first target position and a second target position respectively from the first adjustment position and the second adjustment position by adjusting positions such that the first object and the second object are positioned closer to the reference point.

14. The server of claim 13, wherein the program further includes instructions for:
determining whether the first object is movable;
determining that the first object is not movable in a case in which a boundary of the first object overlaps with a boundary of the 3D load space or a boundary of the second object after the first object is moved by a unit distance in an x-axis direction and in a y-axis direction from an m-th position where the first object moves m−1 times by the unit distance from the first adjustment position, wherein m is a natural number greater than or equal to 1;
in response to a determination that the first object is not movable, determining the m-th position as the first target position; and
in response to a determination that the first object is movable from the m-th position by the unit distance in a first direction among the x-axis and the y-axis, determining a position at which the first object is moved by the unit distance in the first direction as an m+1-th position of the first object.

15. The server of claim 13, wherein the program further includes instructions for:
determining a plurality of orders of an object of which a target position is to be determined among the first object and the second object; and
determining a first position corresponding to the first object and a second position corresponding to the second object according to each of the plurality of orders.

16. The server of claim 15, wherein:
the first position is a position of the first object at which a boundary of the first object is to be positioned closest to the reference point without deviating from the x-axis and the y-axis and without crossing a boundary of the second object; and
the second position is a position of the second object at which the boundary of the second object is to be positioned closest to the reference point without deviating from the x-axis and the y-axis and without crossing the boundary of the first object.

17. The server of claim 16, the program further includes instructions for:
calculating a load rate corresponding to the target position of each of the first object and the second object determined according to each of the plurality of orders; and
determining the first position and the second position corresponding to orders of a lowest load rate among the plurality of orders respectively as the first target position and the second target position.
